(19) United States
(12) Patent Application Publication
(10) Pub. No.: US 2018/0169891 A1
(43) Pub. Date: Jun. 21, 2018

(54) ANGLE ADJUSTMENT MECHANISM FOR CIRCULAR SAW

(71) Applicant: REXON INDUSTRIAL CORP., LTD., Taichung (TW)

(72) Inventor: Ci-Fong WEI, Taichung (TW)

(21) Appl. No.: 15/844,935

(22) Filed: Dec. 18, 2017

(30) Foreign Application Priority Data
Dec. 19, 2016 (TW) 105142024

(51) Int. Cl. B27B 9/02; B27B 5/12

(52) U.S. Cl. CPC B27B 9/02; B27B 5/12

(57) ABSTRACT

An angle adjustment mechanism for use in a circular saw including a shoe, a bracket mounted to the shoe, an operating member slidably mounted to the bracket and a cutting unit pivotally mounted between the shoe and the operating member. The angle adjustment mechanism includes a positioning member that has an abutting portion and is mounted to the cutting unit and a limiting member that is pivotally mounted to the bracket and has a stop member operable between a stopping position where the stop member protrudes from the guiding bracket and a releasing position where the stop member is located away from the positioning member. The abutting portion of the positioning member is abuttingly positioned at the stop member when the stop member is located at the stopping position, such that the cutting unit can be quickly positioned to the desired angle.

### BACKGROUND OF THE INVENTION

### 1. Field of the Invention

The present invention relates to circular saw technology and more particularly, to an angle adjustment mechanism for a circular saw. Priority is claimed to Taiwan application Number 105142024, filed on Dec. 19, 2016, the entire disclosure of which is herein incorporated by reference.

### 2. Description of the Related Art

Existing cutting tools (including a miter saw or table saw) commonly have an angle adjustment design for adjusting the cutting angle of the saw blade. Similar designs are seen in Taiwan Patent Numbers M343572, M320478 and 1490066. Although Taiwan Patent Numbers M343572, M320478 disclose adjustment of various cutting angles, these patents do not have a quick positioning design for the positioning of specific angles of high rate of use, or any specific angle for a batch of work pieces. Therefore, in the implementation of a specific angle of high rate of use, or any specific angle for a batch of work pieces, a certain adjustment time is needed to achieve the desired angle adjustment, therefore slowing the adjustment speed and affecting the processing efficiency.

### SUMMARY OF THE INVENTION

The present invention has been developed in view of the above identified circumstances. It is one of the main objects of the present invention to provide an angle adjustment mechanism for a circular saw, which facilitates quick adjustment and positioning capabilities.

To achieve this and other objects of the present invention, an angle adjustment mechanism is used in a circular saw. The circular saw comprises a shoe, a bracket mounted to the shoe, an operating member slidably mounted to the bracket and a cutting unit pivotally mounted between the shoe and the operating member. The shoe comprises a bottom wall. The bracket comprises an arched guide slot which limits the rotation angle of the cutting unit relative to the shoe, and a series of scales (or graduations) arranged along one side of the arched guide slot. The angle adjustment mechanism comprises a positioning member and at least one limiting member, the positioning member has an abutting portion and is mounted to the cutting unit at one side relative to the bracket. Each limiting member is pivotally mounted to the bracket and has a stop member, the stop member is operable between a stopping position which protrudes from the bracket towards the positioning member, and a releasing position which is located away from the positioning member. The abutting portion of the positioning member is abuttingly positioned at the stop member when the stop member of the limiting member is located at the stopping position.

One of the improvements of the present invention is utilizing the cooperation between the positioning member and the limiting member, and utilizing the characteristic that the stop member of the limiting member is operable between a stopping position and a releasing position to enable the cutting unit to be quickly adjusted to a specific cutting angle. The angle adjustment mechanism has the characteristics of a simple structure and an ease of manufacturing and installation.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a circular saw equipped with an angle adjustment mechanism in accordance with the present invention.

FIG. 2 is an enlarged view of a part of FIG. 1.

FIG. 3 is an exploded view of a part of the angle adjustment mechanism in accordance with the present invention.

FIG. 4 is a schematic side view of the present invention, illustrating a 90° contained angle defined between the saw blade and the bottom wall of the shoe.

FIG. 5 is a schematic operational view of the present invention.

FIG. 6 is an enlarged view of a part of FIG. 5.

FIG. 7 is another schematic side view of the present invention, illustrating the contained angle of 45° between the saw blade and the bottom wall.

### DETAILED DESCRIPTION OF THE INVENTION

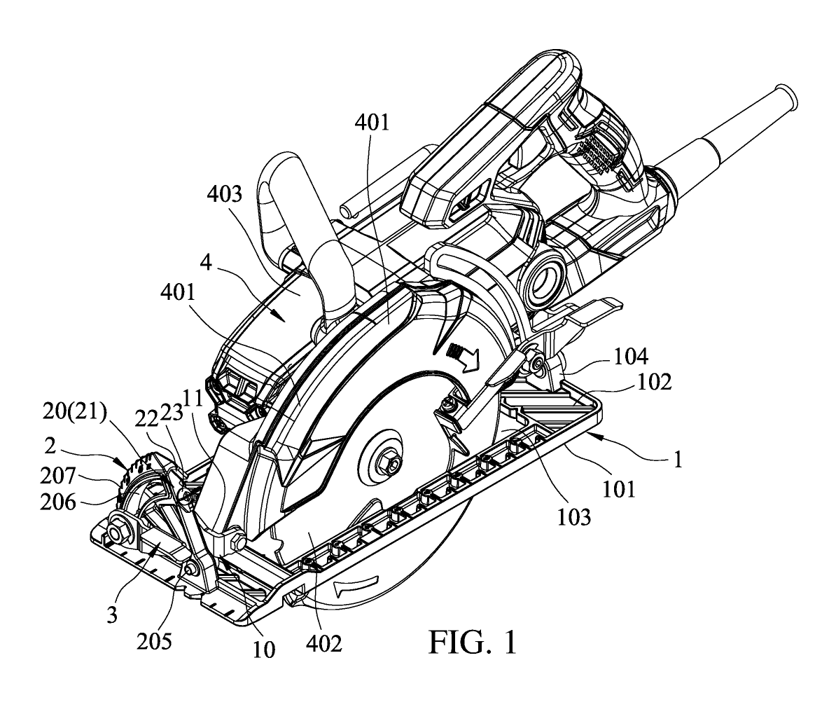

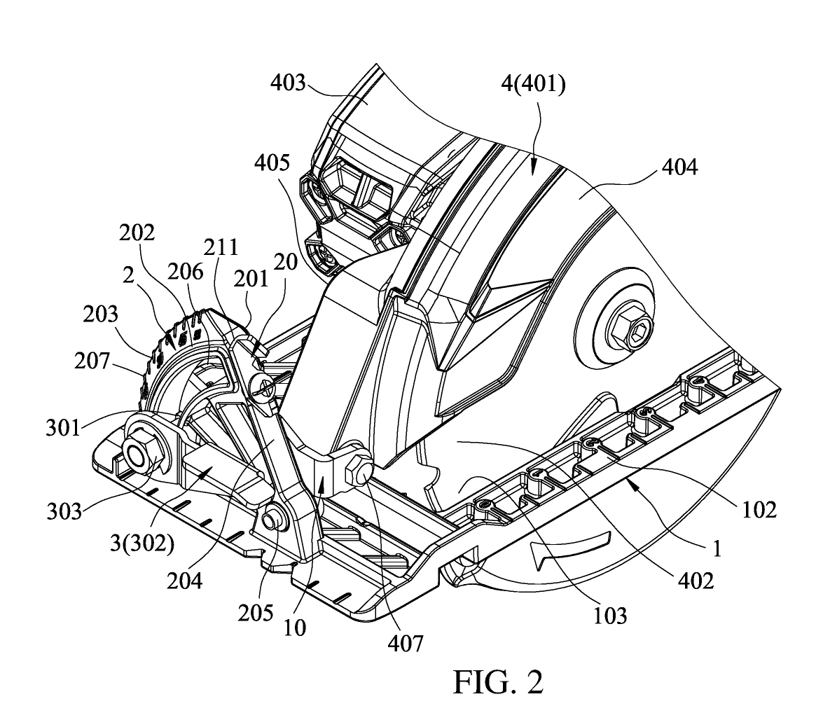

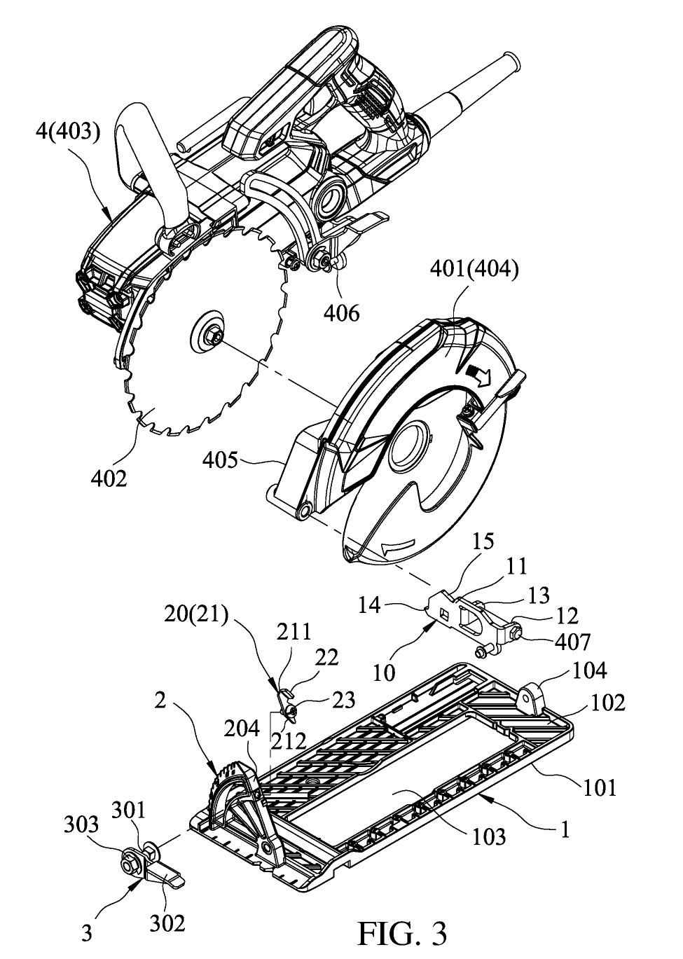

Referring to FIGS. 1-3, an angle adjustment mechanism in accordance with the present invention is used in a circular saw that comprises a shoe 1, a bracket 2 mounted to the shoe 1, an operating member 3 slidably mounted to the bracket 2, and a cutting unit 4 pivotally mounted between the shoe 1 and the operating member 3.

The shoe 1 comprises a bottom wall 101, a top wall 102 opposite to the bottom wall 101, an opening 103 cut through the bottom wall 101 and the top wall 102, and a lug 104 protruded from the top wall 102 at one side of the opening 103.

The bracket 2 is formed integral with the top wall 102 of the shoe 1 and disposed at an opposite side of the opening 103 to face toward the lug 104, comprising an inner wall 201 neighbored to the cutting unit 4, an opposing outer wall 202, a peripheral wall 203 connected between the inner wall 201 and the outer wall 202, a side face 204 connected between the inner wall 201, the outer wall 202 and the peripheral wall 203, a pivot axle 205 disposed adjacent to the top wall 102, an arched guide slot 206 extended around the pivot axle 205 for limiting the turning angle of the cutting unit 4 relative to the shoe 1, and graduations 207 arranged along one side of the arched guide slot 206. The arched guide slot 206 is disposed in communication between the inner wall 201 and the outer wall 202. The graduations 207 are located on the outer wall 202. In this embodiment, the graduations 207 are from 0 to 50 degrees with one at every 5 degrees, further, the maximum graduation value is 53 degrees.

The operating member 3 comprises a sliding rod 301 slidably inserted into the arched guide slot 206, a lever 302 connected to the sliding rod 301 and disposed outside the outer wall 202, and a lock member 303 fastened to the sliding rod 301. In this embodiment, the lock member 303 is a locknut for locking the sliding rod 301 to the arched guide slot 206 in the desired position.

The cutting unit 4 comprises a saw guard 401 pivotally connected between the shoe 1 and the bracket 2, a saw blade 402 pivotally mounted in the saw guard 401, and a driver 403 mounted at the saw guard 401 for driving the saw blade 402 to rotate. The saw guard 401 comprises a first lateral side 404, a second lateral side 405 opposite to the first lateral side 404, a pivot rod 406 located at one end thereof and pivotally coupled to the lug 104, and a fastener 407 located at an opposite end thereof. Further, the saw blade 402 is pivotally connected between the first lateral side 404 and the second lateral side 405.

The angle adjustment mechanism comprises a positioning member 10 and a limiting member 20.

The positioning member 10 is neighbored to (or near) the inner wall 201 at one lateral side relative to the bracket 2 and mounted to the cutting unit 4, comprising a main board 11 that faces toward the inner wall 201, a first locating board 12 interlinked with the main board 11 and affixed to the first lateral side 404, a second locating board 13 interlinked with the main board 11 and affixed to the second lateral side 405, an indicator 14 located at the main board 11 and protruded over the peripheral wall 203 and an abutting portion 15 disposed between the indicator 14 and the second locating board 13. By means of inserting the fastener 407 through the first locating board 12, the positioning member 10 is mounted to the saw guard 401.

The limiting member 20 is pivotally mounted to the side face 204 of the bracket 2, comprising a baffle 21 flatly attached to the side face 204 and an operating portion 22 interlinked with the baffle 21. The baffle 21 comprises a stop member 211, and a pivot connection portion 212 connected to the side face 204 with a screw 23.

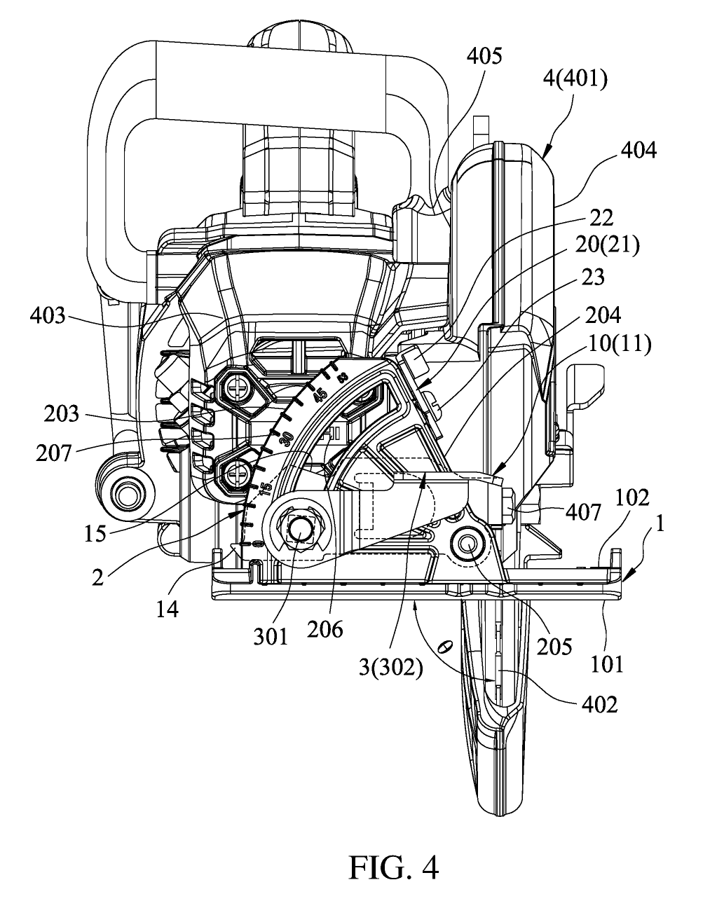

Referring to FIG. 4 and FIGS. 1 and 2, when a 90-degrees contained angle θ is defined between the saw blade 402 and the bottom wall 101 of the shoe 1, the sliding rod 301 is disposed at the bottom end of the arched guide slot 206 near the shoe 1 and the indicator 14 of the positioning member 10 is aimed at the 0-degree graduation 207. The stop member 211 of the baffle 21 is disposed between the inner wall 201 and the outer wall 202 far from the releasing position of the positioning member 10. When starting up the driver 403 at this time, the saw blade 402 is rotated to cut the workpiece at right angles.

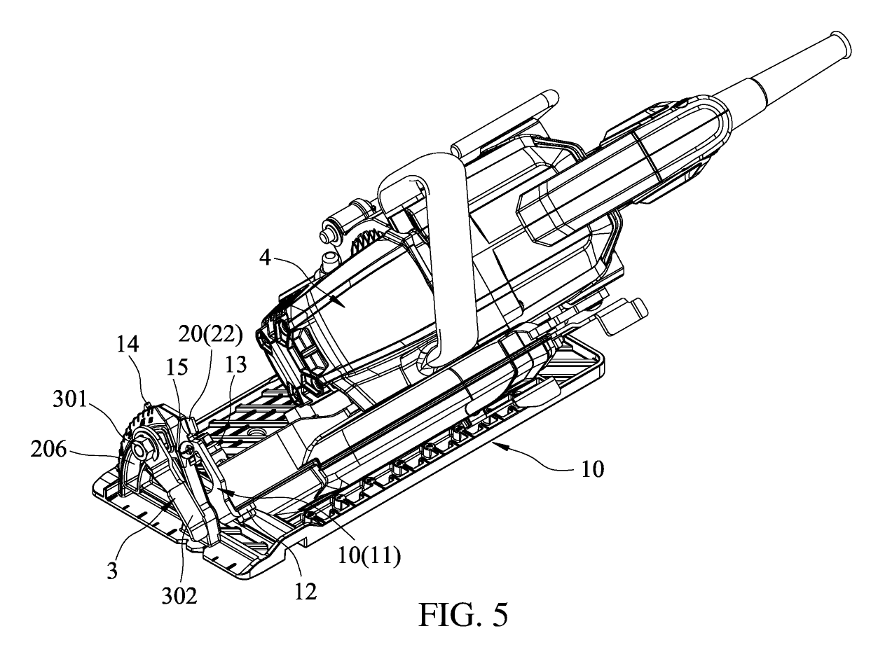

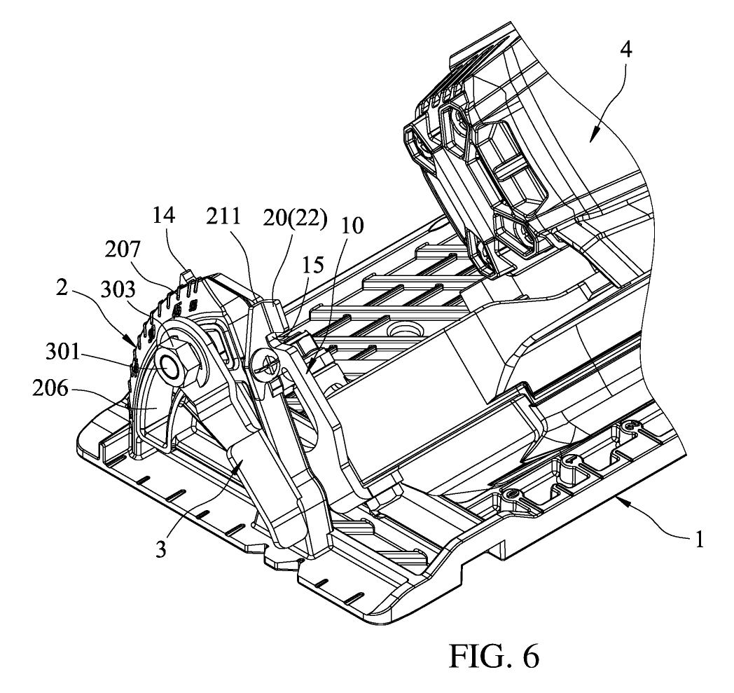

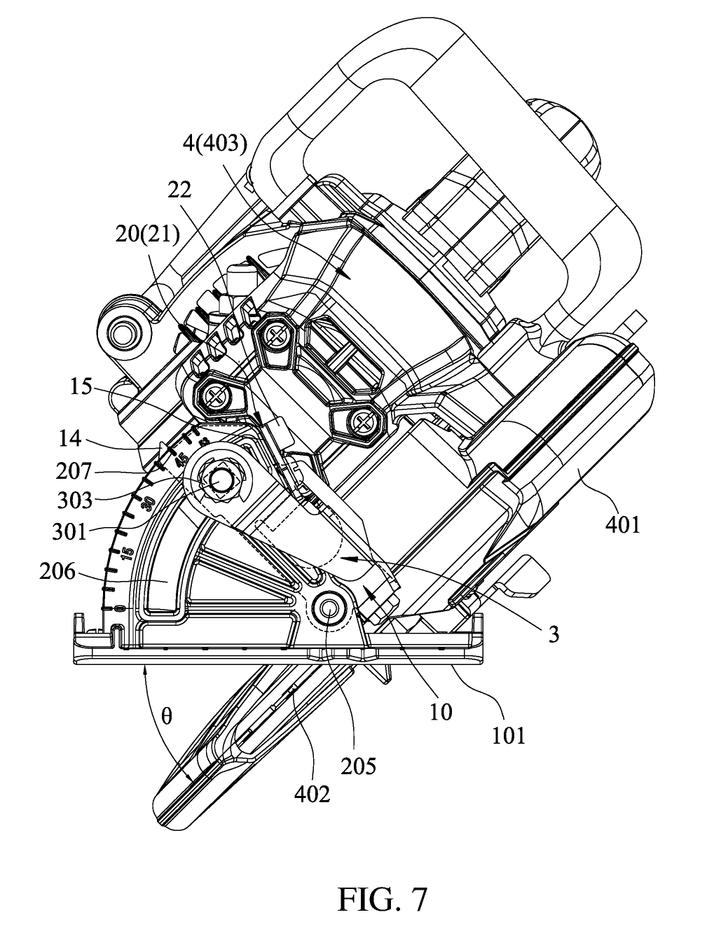

Referring to FIGS. 5-7, when performing a 45-degrees cutting operation, or wishing to cut a lot of work pieces at a 45° angle, the operator can bias the operating portion 22 of the limiting member 20 to move the stop member 211 of the baffle 21 from the releasing position to a stopping position where the stop member 211 protrudes over the inner wall 201 of the bracket 2 and is disposed in proximity to the positioning member 10. Thereafter, before locking up the lock member 303, the operator biases the cutting unit 4 relative to the shoe 1 and the bracket 2, driving the limiting member 20 to force the abutting portion 15 into abutment against the stop member 211. At this time, the indicator 14 is aimed at the 45-degrees graduation 207, and the contained angle θ between the saw blade 402 and the bottom wall 101 of the shoe 1 is 45 degrees. The operator can then fasten tight the lock member 303 to lock the cutting unit 4 to the shoe 1. When starting up the driver 403 at this time, the saw blade 402 is rotated to cut the workpiece at a 45° angle.

Therefore, the present invention utilizes the mating relationship between the positioning member 10 and the limiting member 20, where one of the characteristics is that the limiting member 20 is pivotably mounted to the bracket 2 and that the positioning member 10 is mounted the cutting unit 4, enabling the cutting unit 4 to be quickly adjusted to a 45-degree cutting position for cutting for workpieces at a 45° angle.

Further, by means of the matching between the graduations 207 and the indicator 14 of the positioning member 10, adjustment of the contained angle θ between the saw blade 402 and the bottom wall 101 of the shoe 1 can be conveniently adjusted within the range of 0˜53°.

It should be noted that, in the above-described preferred embodiment of the present invention, only one limiting member 20 is provided for the most commonly used 45° cutting angle. If there are a plurality of cutting grooves (not shown) provided at the bracket and spaced from the peripheral wall 203 toward the pivot axle 205 and respectively disposed corresponding to more commonly used oblique cutting angles, for example, 15 degrees and 30 degrees, additional limiting members 20 can be used to be pivotally connected to each cutting groove, so that the operator can selectively bias one limiting member from the releasing position to the stopping position to achieve quick adjustment of one of a series of oblique cutting angles.

In general, the angle adjustment mechanism has the characteristics of a simple structure and ease of manufacturing and installation, and can accurately achieve the purposes of quick adjustment and positioning.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An angle adjustment mechanism configured to be used in a circular saw comprising a shoe, a bracket mounted to the shoe, an operating member slidably mounted to the bracket and a cutting unit pivotally mounted between the shoe and the operating member, the shoe comprising a bottom wall, the bracket comprising an arched guide slot for limiting a rotating angle of the cutting unit relative to the shoe and a series of scales arranged along one side of the arched guide slot, the angle adjustment mechanism comprising:
a positioning member configured to be mounted to the cutting unit at one side relative to the bracket, the positioning member comprising an abutting portion; and
at least one limiting member configured to be pivotally mounted to the bracket, the at least one limiting member comprising a stop member operable between a stopping position which is configured to protrude from the bracket towards the positioning member and a releasing position which is configured to be located away from the positioning member, wherein the abutting portion of the positioning member is configured to be abuttingly positioned at the stop member when the stop member of the limiting member is located at the stopping position, when the positioning member and the at least one limiting member are mounted to the circular saw.

2. The angle adjustment mechanism as claimed in claim 1, wherein the bracket comprises an inner wall neighbored to the positioning member, an outer wall opposite to the inner wall, and a periphery connected between the inner wall and the outer wall; the arched guide slot is disposed in communication between the inner wall and the outer wall; the scales are arranged on the outer wall; the positioning member further comprises an indicator protruding from the periphery for aiming at the scales when the cutting unit is rotated relative to the shoe and the bracket.

3. The angle adjustment mechanism as claimed in claim 2, wherein the cutting unit comprises a saw guard pivotally connected between the shoe and the bracket, a saw blade pivotally mounted in the saw guard and a driver mounted at the saw guard for driving the saw blade to rotate, the saw guard comprising a first lateral side and a second lateral side opposite to the first lateral side; the saw blade is pivotally mounted between the first lateral side and the second lateral side; the positioning member is mounted at the saw guard and further comprises a main board configured to face toward the inner wall, a first locating board interlinked with the main board and fastened to the first lateral side, and a second locating board interlinked with the main board and fastened to the second lateral side; wherein the indicator is located at the main board.

4. The angle adjustment mechanism as claimed in claim 3, wherein when the stop member of the limiting member is set in the stopping position, the indicator of the positioning member is aimed at a 45° graduation on the scale, and a 45° contained angle is defined between the saw blade and the bottom wall.

5. The angle adjustment mechanism as claimed in claim 4, wherein the bracket further comprises a side face connected to the inner wall, the outer wall and the periphery; and wherein the limiting member is mounted to the side face using a screw.

6. The angle adjustment mechanism as claimed in claim 5, wherein the limiting member further comprises a baffle flatly attached to the side face; the operating portion is interlinked with the baffle; when the stop member of the limiting member is set in the stopping position, the stop member protrudes from the inner wall; wherein when the stop member of the limiting member is set in the releasing position, the stop member is disposed between the inner wall and the outer wall.

7. A circular saw comprising a shoe, a bracket mounted to the shoe, an operating member slidably mounted to the bracket and a cutting unit pivotally mounted between the shoe and the operating member,
the shoe comprising a bottom wall,
the bracket comprising an arched guide slot for limiting a rotating angle of the cutting unit relative to the shoe and a series of scales arranged along one side of the arched guide slot,
an angle adjustment mechanism comprising:
a positioning member mounted to the cutting unit at one side relative to the bracket, the positioning member comprising an abutting portion, and
at least one limiting member mounted to the bracket, the at least one limiting member comprising a stop member operable between a stopping position which is configured to protrude from the bracket towards the positioning member and a releasing position which is configured to be located away from the positioning member, wherein the abutting portion of the positioning member is configured to be abuttingly positioned at the stop member when the stop member of the limiting member is located at the stopping position.
